(19) United States
(12) Patent Application Publication
(10) Pub. No.: US 2010/0019460 A1
(43) Pub. Date: Jan. 28, 2010

(54) Embossed end cover and/or combustion casing gasket and related method

(75) Inventors: Todd D. Paquin, Easley, SC (US); James C. Monaghan, Moore, SC (US); Jeffrey Lebegue, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/219,458

(22) Filed: Jul. 22, 2008

(51) Int. Cl. F02F 11/00

(52) U.S. Cl. 277/595; 277/313

(57) ABSTRACT

A gasket assembly includes a closed periphery core of compressible sealing material, the core having top and bottom surfaces and inner and outer edges; a first cover component enclosing at least the outer edge of the closed periphery core; and a second cover component enclosing the inner edge of the closed periphery core and extending into overlapping relationship with the first cover component.

This invention relates generally to rotary machine technology, and more specifically, to a new gasket construction for a turbine combustor end cover or casing.

### BACKGROUND OF THE INVENTION

Gaskets are typically employed in turbine combustor systems to seal the interface between various combustor components, e.g., combustor end covers and combustor casings, in order to prevent leakage of combustion gases. Currently, such gaskets are composed of graphite serviceable in a range of about 850° F. to 1050° F. in normal environments. However, the graphite gasket material has been known to degrade at temperatures as low as 450° F., apparently due to exposure to combustion gases. There remains a need, therefore, for a gasket construction for use in gas turbine combustion systems that is not subject to the leaking issues currently experienced on a regular basis with graphite gaskets.

### BRIEF DESCRIPTION OF THE INVENTION

In one exemplary but nonlimiting aspect, the present invention relates to a gasket assembly comprising: a core of compressible sealing material, the core having top and bottom surfaces and inner and outer edges; a first cover component enclosing at least the outer edge of the core; and a second cover component enclosing the inner edge of the core and extending into overlapping relationship with the first cover component.

In another aspect, the invention relates to a gasket assembly comprising: a closed periphery core of compressible sealing material, the core having upper and lower planar surfaces and radially inner and outer edges; a first cover component enclosing the radially outer edge and a relatively minor portion of the upper and lower planar surfaces; a second cover component enclosing the radially inner edge and a relatively major portion of the upper and lower planar surfaces, wherein upper and lower sides of the second cover component overlap upper and lower sides of the first cover component; and further wherein free edge portions of the second cover component are formed to include hollow, continuous annular ribs, respectively, projecting away from the closed periphery core.

In still another exemplary but nonlimiting aspect, the invention relates to a method of sealing adjacent, annular bolt flanges on respective machine components comprising: forming an annular gasket groove in one of the bolt flanges; providing an inner core of compressible sealing material; enclosing the inner core with a pair of cover components, one having a radially outer edge and first upper and lower sides, and the other having a radially inner edge and second upper and lower sides that overlap the first upper and lower sides, free end portions of the second upper and lower sides formed to include respective continuous, hollow ribs projecting away from the inner core, the free end portions engageable with the first upper and lower sides; inserting the gasket assembly in the groove; and securing the bolt flanges.

The invention will now be described in connection with the drawings identified below.

### BRIEF DESCRIPTION OF THE DRAWINGS

FIG. 1 is a partial perspective view, partially cut away, illustrating a combustor casing flange formed with a groove for receiving a gasket in accordance with an exemplary embodiment of the invention;

FIG. 2 is an enlarged partial perspective view of a gasket assembly in accordance with an exemplary embodiment of the invention; and

FIG. 3 is a cross section taken through the gasket assembly shown in FIG. 3, and seated in the casing groove shown in FIG. 1.

### DETAILED DESCRIPTION OF THE INVENTION

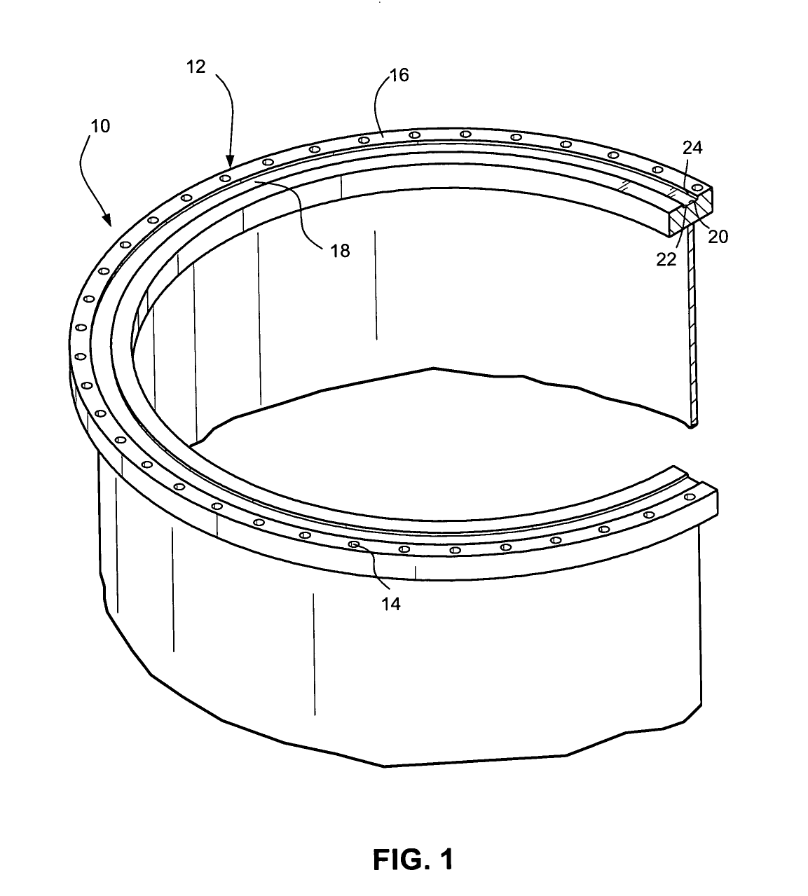

With reference initially to FIG. 1, a combustor casing 10 is formed with, or provided with, a bolt flange 12 at one end thereof, the bolt flange formed with a circular array of bolt holes 14 used to secure the casing 10 to another machine component. The forward or mounting surface 16 of the bolt flange 12 is also formed with a gasket groove 18 radially inwardly of the array of bolt holes 14. The gasket groove 18 is in the form of an open channel, and includes a base surface 20, an inside groove wall 22 and an outside wall 24. The groove is sized to receive a gasket 26 assembly described in further detail below.

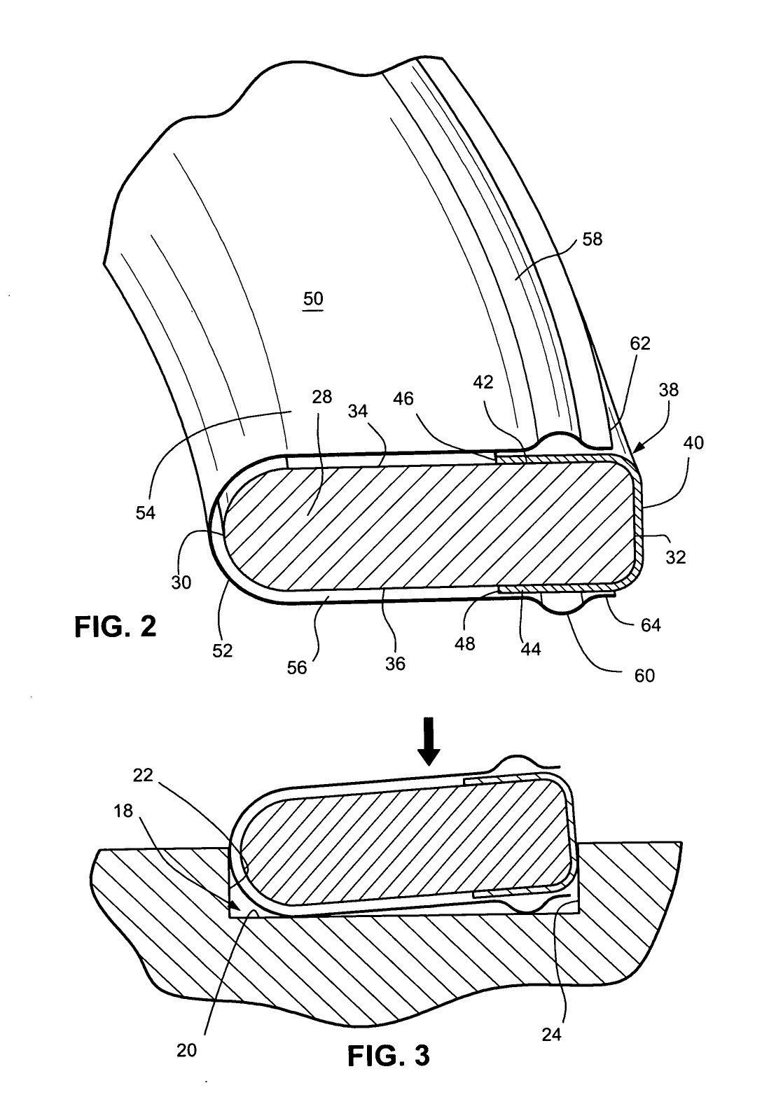

Turning to FIGS. 2 and 3, the gasket assembly 26 is formed with an inner closed periphery core 28 of relatively soft sealing material, preferably graphite, the surface properties of which are similar to graphite gaskets currently in use. The core 28 has inner and outer edges 30, 32 and top and bottom surfaces 34, 36, respectively. A substantially backwards C-shaped platen ring (or first inner cover component) 38 having an outer edge 40 and upper and lower sides 42, 44 is applied over the radially outer edge 32 of the graphite core 28 and minor portions of the top and bottom surfaces 34, 36, terminating at edges 46, 48. The platen ring 38 is preferably constructed of a relatively heavy stainless steel material that is precompressed, and thus not easily deformed from the shape illustrated in the drawings.

A substantially C-shaped second outer cover component 50 having an inner edge 52 and upper and lower sides 54, 56 encloses the inner edge 30 of the core 28, extending over the remaining major portions of the top and bottom surfaces 34, 36 of the core and overlapping the upper and lower sides 42, 44 of the platen ring 38.

The outer cover component 50 is preferably constructed of a softer metal such as copper, and the upper and lower sides 54, 56 thereof are formed with embossments 58, 60 adjacent free edges 62, 64 thereof. The embossments 58, 60 comprise continuous hollow ribs that extend about the entire closed periphery of the gasket. Note that the free edges 62, 64 terminate short of, but adjacent the outer edge 40 of the platen ring 38. Thus, the inner and outer components 38, 50 may be assembled about the core 28 by pushing the inner and outer components 38, 50 over the core 28 from opposite directions such that the upper and lower sides 54, 56 of the outer component 50 overlap the upper and lower sides 42, 44 of the inner component 38.

When installed, the inner edge 52 of the outer cover component 50 and the inner edge 40 of the platen ring 38 will engage the inner and outer walls 22, 24 of the groove 18. When a matching bolt flange of another component (not shown) is applied to the bolt flange 12 and tightened, the gasket assembly 26 will be fully seated in the groove 18, and embossments 42, 44 will be compressed and deformed as needed to conform with surface irregularities on the opposed bolt flanges. At the same time, the graphite core 28 remains fully enclosed and thus protected from harmful combustion gases. Note that the heavier first, inner cover component or platen ring 38 allows the embossments 42, 44 to be compressed onto a solid backing (I.e., the platen ring) as the gasket is installed, preventing damage to the core 28. In addition, by terminating the free edges 62, 64 of the second cover component 50 short of the inner edge 40 of the platen ring 38, space is provided for some radial expansion of the embossed edges under compression, uninhibited by the outer groove wall 24, best appreciated from FIG. 3.

The ability of the gasket assembly 26 to conform to surface irregularities and to also protect the inner graphite core 28 from exposure to harsh conditions, substantially eliminates leakage issues experienced with unprotected graphite gaskets.

It will be appreciated that the gasket construction need not be of a closed periphery design, but may also be used where other machine components are joined, with gaskets required only in certain areas thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A gasket assembly comprising:
a core of compressible sealing material, said core having top and bottom surfaces and inner and outer edges;
a first cover component enclosing at least said outer edge of said core; and
a second cover component enclosing said inner edge of said core and extending into overlapping relationship with said first cover component.

2. The gasket assembly of claim 1 wherein said first cover component has upper and lower sides that extend over portions of said top and bottom surfaces of said core, and said second cover component has upper and lower sides that extend over portions of said top and bottom surfaces of said core not covered by said first component.

3. The gasket assembly of claim 2 wherein said upper and lower sides of said second cover component are each formed with a continuous, compressible hollow rib.

4. The gasket assembly of claim 3 wherein said continuous, compressible hollow ribs lie in proximity to an outer edge of said first cover component.

5. The gasket assembly of claim 1 wherein said first cover component is constructed of precompressed stainless steel.

6. The gasket assembly of claim 1 wherein said second cover component is constructed of copper.

7. The gasket assembly of claim 5 wherein said second cover component is constructed of copper.

8. The gasket assembly of claim 1 wherein said core is circular in shape.

9. The gasket assembly of claim 3 wherein said core comprises graphite.

10. A gasket assembly comprising:
a closed periphery core of compressible sealing material, said core having upper and lower planar surfaces and radially inner and outer edges;
a first cover component enclosing said radially outer edge and a relatively minor portion of said upper and lower planar surfaces;
a second cover component enclosing said radially inner edge and a relatively major portion of said upper and lower surfaces, wherein upper and lower sides of said second cover component overlap upper and lower sides of said first cover component; and
further wherein free edge portions of said second cover component are formed to include hollow, continuous annular ribs, respectively, projecting away from said closed periphery core.

11. The gasket assembly of claim 10 wherein said free edge portions terminate adjacent said radially outer edge of said closed periphery core.

12. The gasket assembly of claim 10 wherein said first cover component is constructed of precompressed stainless steel.

13. The gasket assembly of claim 10 wherein said second cover component is constructed of copper.

14. The gasket assembly of claim 12 wherein said second cover component is constructed of copper.

15. The gasket assembly of claim 10 wherein said closed periphery core is comprised of graphite.

16. A method of sealing adjacent, annular bolt flanges on respective machine components comprising:
forming an annular gasket groove in one of said bolt flanges;
providing an inner core of compressible sealing material;
enclosing said inner core with a pair of cover components, one having a radially outer edge and first upper and lower sides, and the other having a radially inner edge and second upper and lower sides that overlap said first upper and lower sides, free end portions of said second upper and lower sides formed to include respective continuous, hollow ribs projecting away from said inner core, said free end portions engageable with said first upper and lower sides to thereby form a gasket assembly;
inserting said gasket assembly in said groove; and
securing said bolt flanges.

17. The method of claim 16 wherein said second cover component is constructed of copper.

18. The method of claim 17 wherein said first cover component is constructed of stainless steel.

19. The method of claim 18 wherein said inner core is comprised of graphite.

20. The method of claim 16 wherein said free edge portions terminate adjacent said radially outer edge of said one cover component.
